(19) United States
(12) Patent Application Publication
(10) Pub. No.: US 2005/0076782 A1
(43) Pub. Date: Apr. 14, 2005

(54) Gas scrubber

(76) Inventor: Milton Lawrence Weinbren, Sandhurst (ZA)

Correspondence Address: BURNS DOANE SWECKER & MATHIS L L P, POST OFFICE BOX 1404, ALEXANDRIA, VA, 22313-1404, US

(21) Appl. No.: 10/499,700

(22) PCT Filed: Nov. 26, 2002
(86) PCT No.: PCT/IB02/04937

(30) Foreign Application Priority Data
Dec. 21, 2001 (ZA) 01/10511

(51) Int. Cl. B01D 53/14

(52) U.S. Cl. 96/306

(57) ABSTRACT

The invention concerns a gas scrubber (10) for scrubbing a gas of particles carried by the gas. The scrubber includes a duct (12) for conveying the flow of gas which is to be scrubbed. In the duct the gas, typically air, is mixed with a scrubbing liquid, typically clean water. The gas/liquid mixture is then subject to multiple scrubbing stages each designed to promote good contact between the gas-conveyed particles and the liquid. The first scrubbing stage includes an inductor (48) of reduced transverse dimension. The second scrubbing stage is provided by a transverse barrier (50.4) in the duct against which the gas/liquid mixture is caused to impact. The third scrubbing stage makes use of an impeller (50) which causes the gas/liquid mixture to swirl outwardly and impact against the duct (12). After the scrubbing stages, the gas/liquid mixture is subjected to centrifugal separation in a multi-stage centrifugal separator (49) which separates the liquid and gas components.

### BACKGROUND TO THE INVENTION

THIS invention relates to a gas scrubber.

Gas scrubbers are used in many industrial processes and applications to clean gases, typically air. This may be for environmental purposes or to render the air suitable for recycling to the process by removing dust or other solid contaminants. Known scrubbers generally work on the principle of bringing a contaminated air flow into contact with water or other liquid droplets so that the particulate contaminants adhere to the droplets as a result of surface tension effects, thereafter separating the cleaned air component from the liquid component and, if necessary, removing the solid contaminants from the liquid to allow the liquid to be recycled.

Known scrubbers for large industrial applications tend to be very large, bulky and expensive.

U.S. Pat. No. 4,171,961 discloses an arrangement for intercepting entrained contaminants from a gaseous medium. A contaminated gaseous medium and droplets of a scrubbing liquid are admitted into a whirling chamber. The scrubbing liquid and gaseous medium become admixed such that the scrubbing liquid can intercept contaminants. U.S. Pat. No. 4,624,688 discloses a device for centrifugal separation on the basis of the specific gravity. The operation of the device is based on rotational motion in the same direction, the separation being carried out by changing angular velocities of the rotational motion. EP 1082989 discloses an air scrubbing method and apparatus comprising multiple purification stages and employing coarse and fine filtration devices and a solvent composition which breaks down paint particles.

### SUMMARY OF THE INVENTION

According to the present invention there is provided a gas scrubber for scrubbing a gas of particles carried by the gas, the scrubber comprising:
a duct for conveying a flow of gas to be scrubbed;
means for mixing the gas flow with a scrubbing liquid in the duct;
first, second and third scrubbing stages in the duct, each serving to promote contact between the liquid and the particles, the first scrubbing stage including an inductor of reduced transverse dimension, the second scrubbing stage comprising a transverse barrier in the duct against which the gas/liquid mixture is caused to impact, and the third scrubbing stage comprising an impeller for causing the gas/liquid mixture to swirl outwardly and impact against the duct; and
means in the duct downstream of the scrubbing stages to separate the gas from the liquid.

According to another aspect of the invention there is provided a method of scrubbing a gas of particles carried by the gas, the method comprising the steps of:
causing a flow of gas which is to be scrubbed to flow through a duct,
in the duct, mixing the gas with a scrubbing liquid to form a gas/liquid mixture;
to promote contact between the liquid and the particles, subjecting the gas/liquid mixture, in the duct, to:
   a first scrubbing stage in which the gas/liquid mixture is caused to flow through an inductor of reduced transverse dimension,
   a second scrubbing stage in which the gas/liquid mixture is caused to impact against a transverse barrier in the duct,
a third scrubbing stage in which the gas/liquid mixture is caused by an impeller to swirl outwardly and impact against the duct; and
centrifugally separating gas and liquid components of the gas/liquid mixture in duct at a position downstream of the scrubbing stages.

Other features of the apparatus and method of the invention are defined in the appended claims.

### BRIEF DESCRIPTION OF THE DRAWINGS

The invention will now be described in more detail, by way of example only, with reference to the accompanying diagrammatic drawings in which:

FIG. 1 shows a side view of a gas scrubber according to this invention;

FIG. 2 shows a partial, cross-sectional side view of the gas scrubber;

FIG. 3 shows an axial view, taken in the downstream direction, of the centrifugal impeller used in the gas scrubber of the preceding Figures;

FIG. 4 shows a side view of a preferred design of the sump and slurry collection components;

FIG. 5 shows a plan view of the components seen in FIG. 4;

FIG. 6 shows a view of the same components, the view being in the direction of the arrow 6 in FIG. 5; and

FIG. 7 shows a view similar to that of FIG. 4 of a preferred, multi-stage sump and slurry collection design.

### DESCRIPTION OF PREFERRED EMBODIMENTS

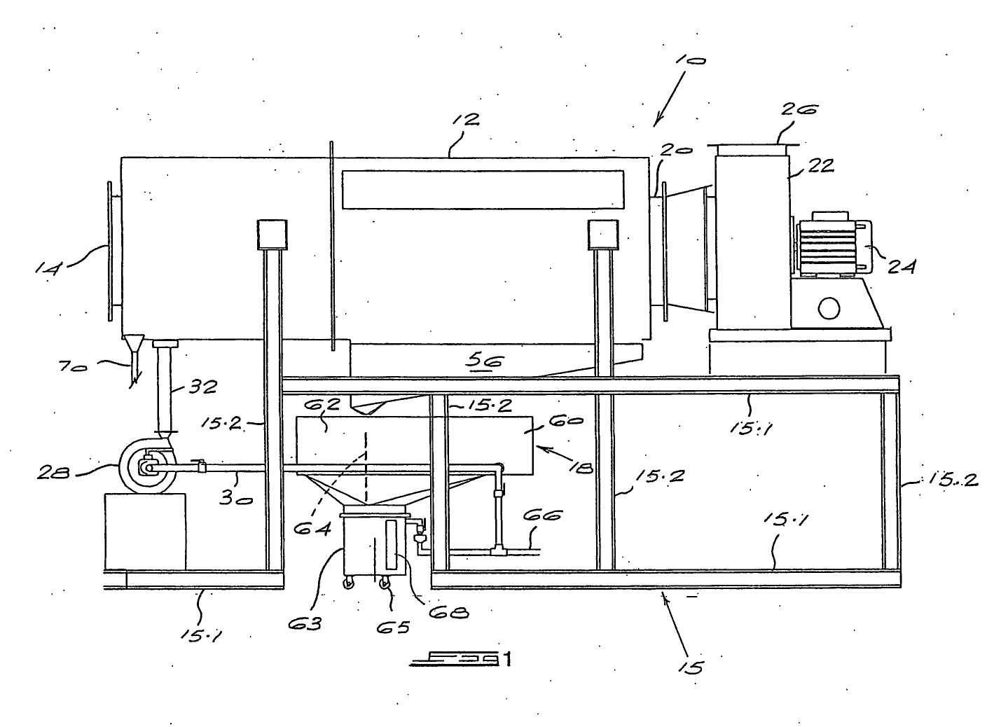

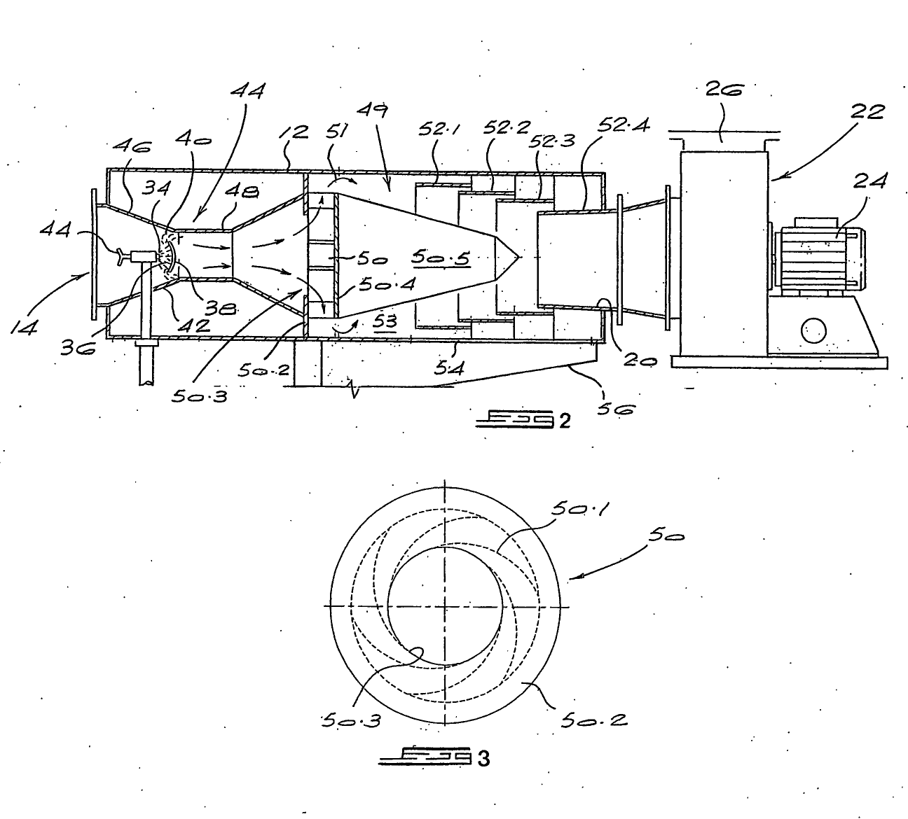

FIGS. 1 and 2 diagrammatically illustrate a gas scrubber 10 according to this invention. In the example described below, the gas which is to be scrubbed is air, but it will be understood that the scrubber of the invention could be used to scrub other gases as well. In the example water is used as the scrubbing liquid but, once again, other scrubbing liquids are also within the scope of the invention.

The air scrubber 10 includes a duct 12 having an axial inlet 14 at one end. The duct is supported, in the illustrated case with its axis horizontal, on a frame 15 having horizontal and vertical members 15.1 and 15.2 respectively. Located beneath the duct 12 is a sump system 18.

Connected to the opposite, outlet end 20 of the duct is a centrifugal fan 22 driven by an electrical motor 24. The fan and motor are also mounted on the frame. The fan outlet is indicated by the numeral 26. In use, the fan draws a flow of air through the duct from the inlet 14 to the outlet end 20 and exhausts it through the fan outlet 26.

An electrically powered centrifugal pump 28 receives clean water through a line 30 and pumps it through a line 32 to a nozzle 34. The jet of water 36 which issues from the nozzle 34 impinges on a liquid spreader in the form of a dished member 38 supported centrally in the duct 12 with the concavity of the member facing the nozzle 14. The shape of the member and the water flow parameters are such that the water is deflected outwardly, as an annular curtain 40 of water drops, into a shroud 42 mounted coaxially in the duct. Optimal setting of the water jet can be achieved by manipulation of a control valve 44.

The fan 22 draws air from the inlet 14 through the water curtain 40 in a direction towards the outlet 20. The mixture of air and water passes through a frustonical section 46 of the shroud and from there moves through an inductor which includes a smaller diameter, throat section or vena contracta 48. The air/water mixture is accelerated in this section to a velocity at which turbulent flow conditions prevail with the result that the air and water are thoroughly mixed with one another. The inductor forms a first scrubbing stage of the air scrubber 10.

The air/water mixture is directed by the throat section 48 towards a static impeller 50 which includes a series of helical impeller vanes 50.1 mounted between an upstream plate 50.2 formed with a central orifice 50.3 and a solid, downstream plate 50.4. The upstream plate 50.2 spans transversely across the interior of the duct 12 and the orifice 50.3 therein has approximately the same diameter as the throat section 48. The plate 50.4 is of smaller external diameter than the plate 50.2 as shown. The diameter of the plate 50.4 may, for instance, be approximately 80% of that of the plate 50.2. A central, generally frustoconical member 50.5 extends downstream from the plate 50.4.

The air/water mixture impacts in a generally axial direction against the plate 50.4 which accordingly acts as a barrier to the flow of the air/water mixture. The barrier plate 50.4 forms a second scrubbing stage of the air scrubber 10.

The vanes 50.1 of the static impeller 50 impart an outward, swirling motion to the air/water mixture. As indicated by the numeral 51, the outwardly swirling mixture impacts against the inner surface of the duct 12. Turbulence and thorough mixing of the air and water components is again promoted by the impeller and duct which form a third scrubbing stage of the air scrubber 10.

After impacting against the inner surface of the duct 12, the air/water mixture enters a zone 53 surrounding the member 50.5 and thereafter moves longitudinally into a multi-stage centrifugal separator 49. The centrifugal separator 49 includes a series of axially staggered cylindrical collector rings 52.1, 52.2, 52.3, 52.4 of progressively reducing diameter in the downstream direction. Beneath the rings 52.1 to 52.4 the lower wall of the duct 12 is formed with an outlet 54 leading via an inclined chute 56 to the sump system 18.

Water drops which are thrown outwardly through the greatest radial distance by the impeller 50 deposit on the outer surface of the first ring 52.1. The water then flows around that surface and eventually drops off the ring to leave the duct through the outlet 54 from where it flows to the sump system 18. Water drops which are not thrown out quite as far by the impeller are drawn further downstream by the action of the fan 22, and deposit on the surface of the next ring 52.2 from where, once again, the collected water also finds its way to the sump system 18. The process is repeated throughout the remaining length of the centrifugal separator 49 with those water drops thrown outwardly through the least distance by the impeller eventually being collected by the last ring 52.4 from where the water is once again directed to the sump system.

The member 50.5 of the impeller maintains the spiral swirling motion of the water droplets and reduces the possibility of short-circuiting axially through the collector rings 52.1 to 52.4. Accordingly, the impeller 50 and collector rings 52.1 to 52.4 act together as a multi-stage centrifugal separator. The air component of the original air/water mixture is drawn largely axially through the collector rings and is eventually exhausted by the fan 22 through the fan outlet 26. The water droplets, on the other hand, are effectively separated from the air stream, and are collected by the collector rings which deliver them to the outlet 54.

In the embodiment of FIGS. 1 to 3, the diagrammatically illustrated sump system 18 includes an open-topped sump box 60 and an open-topped collector 62 located within the outer tank. The upper edge of the collector 62 is lower than the upper edge of the sump box 60. The collected liquid, carrying dust particles and other solid contaminants, is delivered by the chute 56 to the collector 62.

Dust and other solid particles which settle in the collector 62 are discharged into a slurry collection container 63 located beneath the sump box 60. In order to achieve optimal settling of the solid contaminants, a suitable flocculant may be used. Clarified liquid, i.e. water, overflows the weir 64 of the collector 62 into the sump box from where it can either be disposed of through a drain line 66 or withdrawn through the line 30 by the pump 28 for recirculation to the nozzle 34.

The slurry collection container 63 is mounted movably on wheels 65 and has a vertical window 68 in its side wall through which the accumulation of solid material can be monitored visually. When a predetermined maximum level of solid material has collected in the container 63, clean water is drained out of it through the drain line 66 and the container is detached from the sump 18 and removed. The collected solids, in the form of a thick slurry, are then removed from the container for disposal as necessary, and the container is re-installed for the scrubbing process to continue.

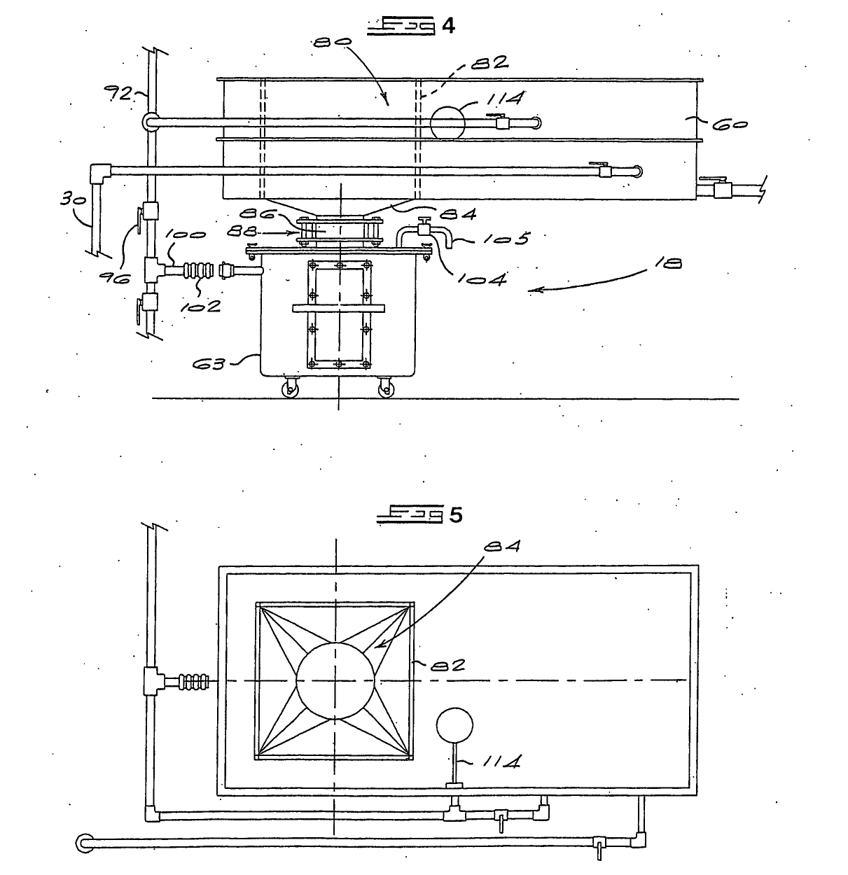

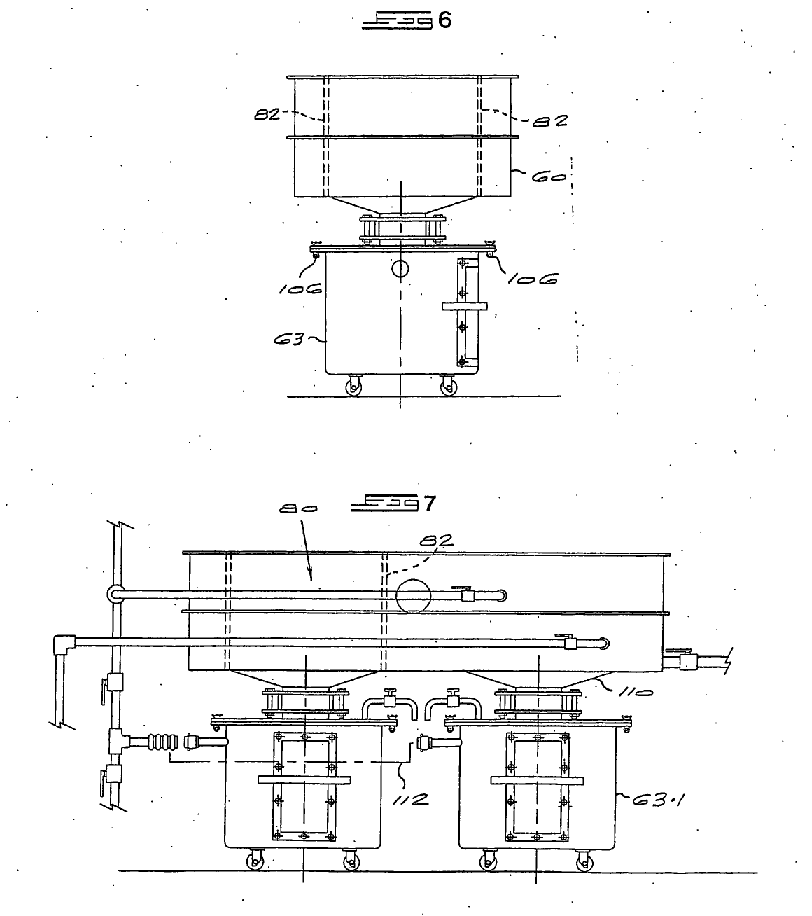

FIGS. 4 to 6 illustrate an alternative, preferred design of the sump and slurry collection components. In this case, the sump box 60 accommodates an internal collector 62 bounded by porous baffle plates 82. A funnel-shaped outlet 84 leads from the bottom of the collector 62 to the slurry collection container 63 via a conduit 86 controlled by a valve 88. During operation of the scrubber 10, the slurry which discharges from the duct 12 through the outlet 54 enters the collector 62. The denser particles in the slurry precipitate through the outlet 84 into the container 63. Cleaner liquid and less dense particles move outwardly through the baffle plates 82 into the surrounding sump box 60. When the container 63 is full of dense slurry, as determined by visual inspection through the inspection window 68, the valve 88 is closed to isolate the container.

In FIG. 4 the numeral 92 indicates a clean water supply line and the numeral 94 indicates an extension line going to drain. Valves 96 and 98 respectively control flow through these lines. A line 100 including a quick-coupler 102 extends to the container 63. With the valve 96 closed and the valve 98 open, liquid above the slurry in the container can be drained off through the lines 100 and 94. To allow this to happen a valve 104 is opened in an air vent 105 to permit air to enter the container. When the liquid has drained off, the quick-coupler 102 is released and bolts 106 are released to allow the container 63 to separated from the sump box 60 for removal of the slurry therein. The clean container 63 is then reconnected to the conduit 86, and the quick-coupler 102 is connected again, whereafter the valve 98 is closed and the valve 96 is opened to admit clean water to the container. Sufficient replenishment of water is indicated by water flowing from the air vent 105. The valves 96 and 104 are then closed again, and the valve 88 is reopened.

Throughout the operation described above, the scrubber 10 continues to operate normally. While the valve 88 is closed, there is merely a build-up of slurry in the collector 62 which gravitates into the container 63 when normal slurry removal operations start again. The volume of clean water admitted to the container dilutes the accumulated, dense slurry which enters the container 63 at this stage.

FIG. 7 shows a slightly more sophisticated arrangement in which there is a separation of heavy and light slurry components. In this case, lighter slurry which has passed outwardly through the baffle plates 82 into the main body of the sump 18 precipitates through an outlet 110 into a second slurry collection container 63.1. This operates in exactly the same way as the primary container 63 and is drained and replenished in like manner. In FIG. 7 the line 112 indicates that the quick-coupler in the line 100 can be coupled selectively to the container 63 or the container 63.1, depending on which of these containers is to be separated and emptied of slurry.

In FIGS. 4, 5 and 7 the numeral 114 indicates an automatic, float-controlled make-up valve, connected to the clean water supply line 96, through which make-up water can be added to the sump system 18 to replenish water losses automatically.

Referring to FIG. 1, there is a line 70 to convey water from the duct 12. In practice, this line can discharge such water into the sump 18, again for make-up purposes.

As described above there is a three stage scrubbing action resulting from the intimate mixing of the air and water components taking place firstly in the vicinity of the throat section 48, secondly on impacting the plate 50.4 and thirdly on impacting the inner surface of the duct 12. As a result of this multi-stage scrubbing action, intimate contact between the water drops and particles of dust and other solid contaminants is promoted. The solid particles adhere to the water droplets through surface tension effects and are accordingly removed from the air stream, along with the water, and with a high degree of efficiency.

In trials scrubbers of the kind described above were able to remove in excess of 99% of an initial dust content of an air flow down to particle sizes as low as 0, 1 micron and even less. It is believed that such high efficiency levels are attributable to the three stage scrubbing action.

Apart from its efficient operation a major advantage of a scrubber as described above is its relative compactness and lightness compared to prior art scrubbers capable of handling a comparable throughput. In practice, the scrubber could be utilised as a stand-alone scrubber, as a pre-scrubber or as a final filter scrubber at the end of a process, i.e. the duct 12 and associated apparatus can be added as a downstream addition to an existing scrubber. It is also possible to retrofit the scrubber 10 to existing ductwork.

It should be noted that the fan 22 and motor 24 are optional and are provided to increase the flow rate through the scrubber and hence its capacity. In the absence of the fan, an air flow will be induced through the scrubber naturally by the action of the throat 48.

1. A gas scrubber for scrubbing a gas of particles carried by the gas, the scrubber comprising:
a duct for conveying a flow of gas to be scrubbed;
means for mixing the gas flow with a scrubbing liquid in the duct;
first, second and third scrubbing stages in the duct, each serving to promote contact between the liquid and the particles, the first scrubbing stage including an inductor of reduced transverse dimension, the second scrubbing stage comprising a transverse barrier in the duct against which the gas/liquid mixture is caused to impact, and the third scrubbing stage comprising an impeller for causing the gas/liquid mixture to swirl outwardly and impact against the duct; and
a centrifugal separator in the duct downstream of the scrubbing stages to separate the gas from the liquid, the centrifugal separator comprising multiple stages defined by concentric, axially staggered liquid collector rings of progressively reducing diameter.

2. A gas scrubber according to claim 1 wherein the means for mixing the gas flow with a scrubbing liquid comprises a liquid spreader located axially in the duct and a nozzle aligned with the spreader to project an axial flow of liquid onto the spreader.

3. A gas scrubber according to claim 2 wherein the spreader comprises a dished element the concavity of which faces the nozzle.

4. A gas scrubber according to any one of the preceding claims wherein the inductor of the first scrubbing stage comprises a throat of reduced diameter in the duct through which gas to be scrubbed passes after the mixture with the liquid.

5. A gas scrubber according to claim 4 comprising a static impeller including vanes mounted to a transverse plate, the transverse plate forming the transverse barrier of the second scrubbing stage against which air/liquid mixture passed by the throat impacts, and the static impeller being the impeller of the third scrubbing stage with the vanes of the static impeller being arranged to impact an outward swirling motion to gas/liquid mixture which has impacted against the transverse plate.

6. A gas scrubber according to any one of the preceding claims wherein the duct has an inlet for gas to be scrubbed, a first outlet for scrubbed gas and a second outlet for liquid carrying particles scrubbed from the gas.

7. A gas scrubber according to claim 6 including a fan for drawing a flow of gas to be scrubbed through the duct from the inlet to the first outlet.

8. A gas scrubber according to claim 6 including a sump system for receiving liquid from the second outlet.

9. A gas scrubber according to claim 8 wherein the sump system comprises a sump box and a slurry collection container for collecting slurry precipitated in a slurry collector in the sump box, the slurry collection container being separable from the sump box for removal of slurry therefrom.

10. A method of scrubbing a gas of particles carried by the gas, the method comprising the steps of:
causing a flow of gas which is to be scrubbed to flow through a duct;
in the duct, mixing the gas with a scrubbing liquid to form a gas/liquid mixture;
to promote contact between the liquid and the particles, subjecting the gas/liquid mixture, in the duct, to:
a first scrubbing stage in which the gas/liquid mixture is caused to flow through an inductor including a throat of reduced transverse dimension,
a second scrubbing stage in which the gas/liquid mixture is caused to impact against a transverse barrier in the duct,
a third scrubbing stage in which the gas/liquid mixture is caused by an impeller to swirl outwardly and impact against the duct; and
centrifugally separating gas and liquid components of the gas/liquid mixture in the duct at a position downstream of the scrubbing stages.
